(19) United States
(12) Patent Application Publication
(10) Pub. No.: US 2007/0170626 A1
(43) Pub. Date: Jul. 26, 2007

(54) Panel positioning device

(75) Inventors: Chiuan-Che Shiu, Padeh City (TW); Chih-chiang Lee, Padeh City (TW); Kuo-Chang Teng, Padeh City (TW)

Correspondence Address: BIRCH STEWART KOLASCH & BIRCH, PO BOX 747, FALLS CHURCH, VA, 22040-0747, US

(73) Assignee: CHUNGHWA PICTURE TUBES, LTD

(21) Appl. No.: 11/339,691

(22) Filed: Jan. 26, 2006

(51) Int. Cl. B25B 11/00

(52) U.S. Cl. 269/21

(57) ABSTRACT

A panel positioning device utilizes fixed positioning elements and the trench so as the fixed positioning device may apply to the panel with different sizes. The positioning element may slide in the trench to the corresponding location and be fixed there. The location where the positioning element fixed in is a gap between the panel and the printed wiring board (PWB) or at an edge of the panel.

### BACKGROUND OF THE INVENTION

1. Field of the Invention

The present invention generally relates to a panel positioning device, and more particularly relates to a display panel positioning device in the manufacturing of the display panel.

2. Description of the Prior Art

Accordingly the requirement of the trend of large-scale and thin film Liquid crystal display panel (LCD panel), the difficulty of the related manufacturing technology becomes higher, such as the control of thin cell gap, stacking and aligning of panel, the movement and position of the large-scale panel, and the wide viewing problem. Wherein, the transportation and position of the panel is one of main reasons causing the scrap damage of the panel. Thus, the prevention of the scrape damage on the sliding panel may effectively improve the yield of the process.

For example, the polarizer peeling off machine usually utilizes the block to fix and locate the panel keep to the side. Once the panel has a printed wiring board (PWB) therewith, it is necessary to change the direction of the panel for peeling off the polarizer and so as it must use the large size of the machine. As peeling off the polarizer, owing to the starting point not in the center portion of the panel, it easily causes the sliding or the movement of the panel to scrape the backside or cause the scrap damage. However, there is generating an upward force as peeling off the polarizer and it easily causes the warped panel. Besides, as the panel size is larger, the amount of PWB is corresponding increased and it increases the degree of the difficulty to position and fix the large-scale panel. Hence, it is important to solve those problems on development of the large-scale panel.

### SUMMARY OF THE INVENTION

In order to solve the problems mentioned above, the present invention provides a panel positioning device, which may be applied to fix panels with different size. As the panel arranged a plurality of printed wiring boards thereon, the positioning device may effectively overcome the difficulty and increase the stability and the quality of the fixing so as to prevent the scrap damage of the panel.

The fixing problem of the different size panel with printed wiring board is resolved by providing a panel positioning device, which utilizes trenches on the loader and positioning elements in the trench for flexible fixing the panel with different size so as not to increase the size of the machine.

The sliding damage of the panel causing from the bad fixing is improved by providing a panel positioning device utilizes a fixed position mechanism and a vacuum suction system to effectively increase the stability of the panel and decrease the damage of the panel so as to improve the yield of the panel in the manufacturing process.

Accordingly, the present invention is to provide a positioning device for a panel comprising: a loader for setting the panel; a plurality of trenches arranged on the loader; and a plurality of positioning elements, wherein at least any one of the positioning elements is arranged in any one of the trenches, and any one of positioning elements having a protruding portion protruded out the trench and contacting the panel.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is the perspective view of positioning device of an embodiment of the present invention;

FIG. 2 and FIG. 3 are top views of the panel positioning device of an embodiment of the present invention;

FIG. 4A, FIG. 4B and FIG. 4C are cross-section view of an embodiment of the present invention according to A-A, B-B, and C-C cross-sections of FIG. 3; and

FIG.5 is 3-D view of the opening of the panel positioning device of an embodiment of the present invention.

### DESCRIPTION OF THE PREFERRED EMBODIMENT

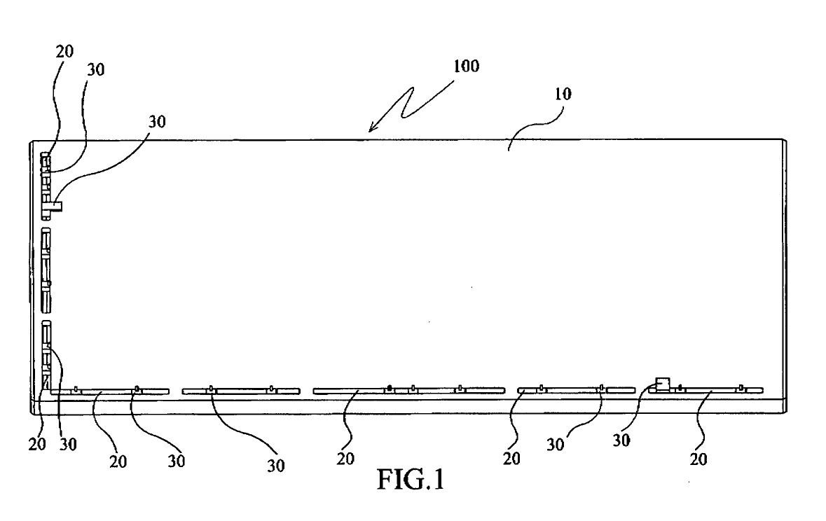

FIG. 1 is a perspective view illustrating the panel-positioning device in accordance with an embodiment of the present invention. In one embodiment, the panel-positioning device 100 includes a loader 10 for setting panel. There are a plurality of trenches 20 and a plurality of positioning elements 30 arranged on the loader 10. Wherein, each trench 20 is arranged at least one or more positioning elements 30 therein. Each positioning element 30 has a protruding portion protruded out the trench 20 for contacting and holding the panel. Each positioning element 30 may slide in the trench 20 to the corresponding location so as to enhance the flexibility for fixing panel. In an embodiment, the protruding portion is upward protruded. In another embodiment, the positioning element 30 is a L-shape profile and bulging out the trench 20, and wherein the protruding portion is extending to the direction of the loader 10 for contacting and holding a side edge of the panel.

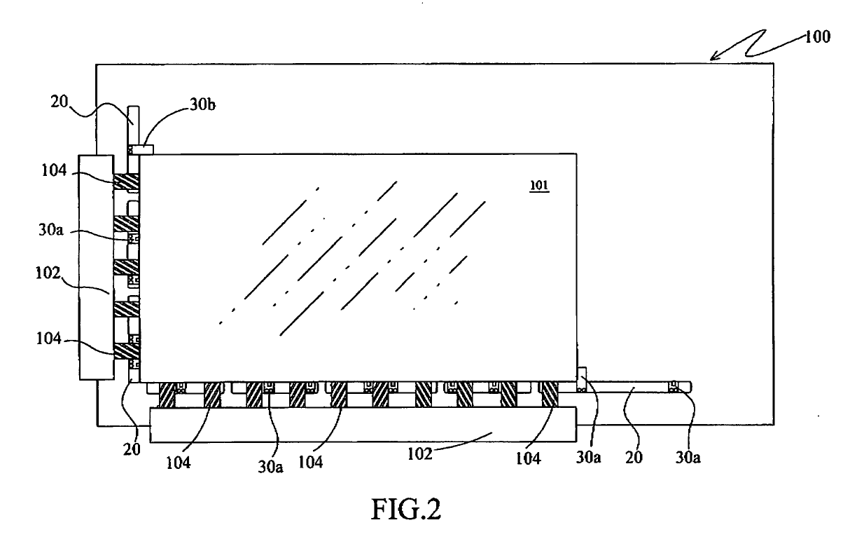

FIG. 2 is a top view illustrating the panel-positioning device in accordance with an embodiment of the present invention. In one embodiment, the panel-positioning device 100 is used for bearing and fixing a panel 101. The panel 101 utilizes a plurality of tapes to electrically connect the panel 101 and the PWB 102 by utilizing the TCP technology. There are gaps between the panel 101 and the PWB 102 and among the tapes 104. Positioning elements may slide appropriate position according to the location of the gap and the panel 101. The protruding portion of each of positioning elements 30a is upward protruding, penetrated through one of gaps between the panel 101 and the PWB 102, and contacting the panel 101. In the trench 20, the positioning element 30b is sliding and moved to a side edge of the pane 101. The positioning element 30 is a L-shape profile and bulging out the trench 20, and wherein the protruding portion is extended to the direction of the loader 10 and contacting and holding the side edge of the panel 101 to stop the side sliding of the panel 101.

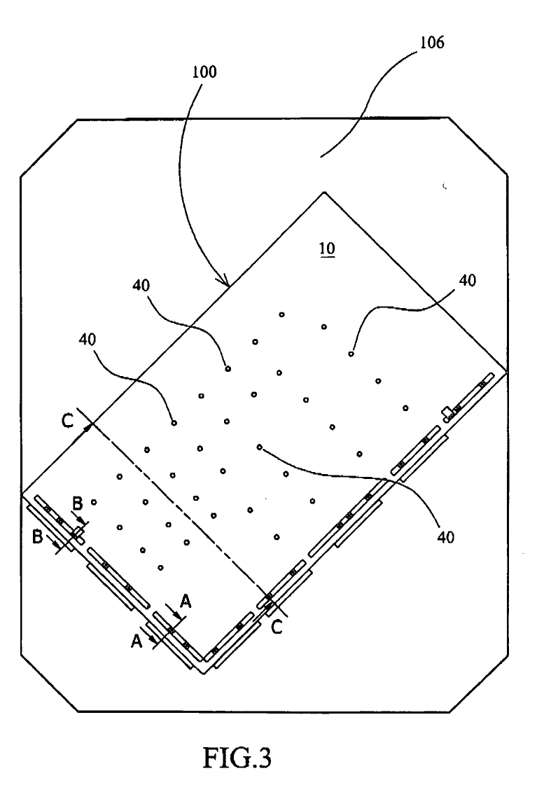

FIG. 3 is a top view illustrating the panel-positioning device in accordance with an embodiment of the present invention. In one embodiment, the positioning device 100 may apply to the panel manufacturing, equipments, such as the polarizer peeling off machine. A loader 10 of the positioning device 100 may be directly arranged on an operation plate 106 for bearing and fixing the panel. There are pluralities of vacuum suction holes 40 distributed on the loader 10 for providing the suction force of the vertical direction for bearing the panel to increase the stability. The arrangement of those vacuum suction holes 40 on the loader 10 is not specific limited and only arranged at the bearing region of the loader 10. Besides, the shape of vacuum suction holes 40 may be in any suitable shape. In one embodiment, those vacuum suction holes 40 may be divided into different area with different vacuum suction systems providing the suction force. According to the size of the panel, vacuum suction holes 40 of the suitable region will provide the vertical suction force to hold the panel so as to enhance the efficiency of the machine and save the energy. As shown in the FIG. 3, the A-A, B-B, and C-C cross-section is for further illustrating the embodiment in the following description.

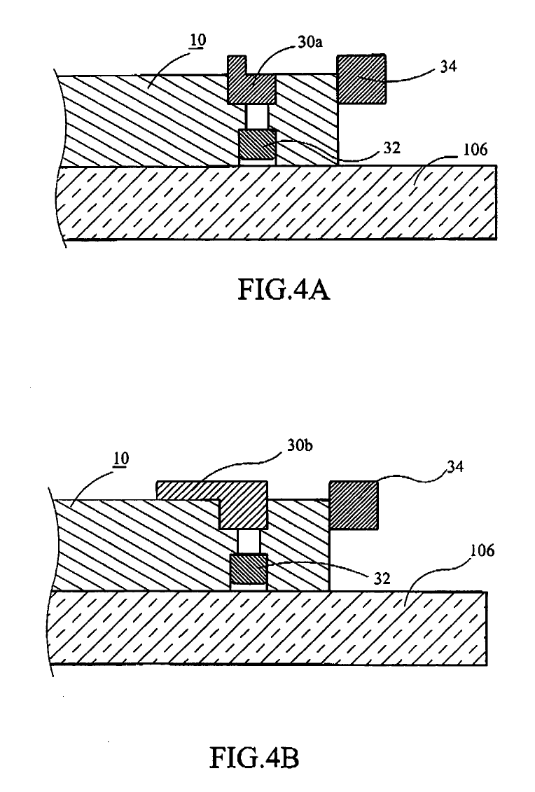

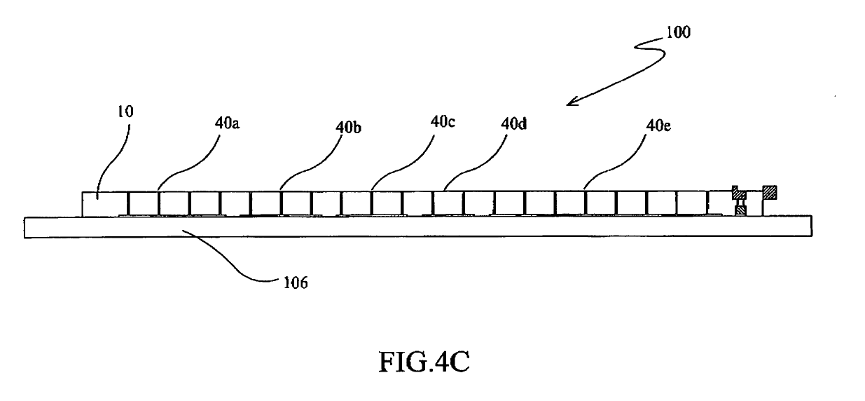

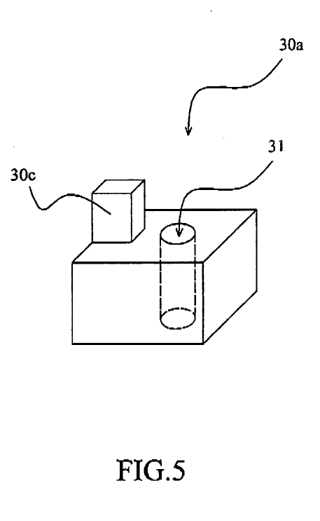

FIG. 4A through FIG. 4C are cross-section views illustrating an embodiment in accordance with the present invention according to A-A, B-B, and C-C cross-sections of FIG. 3. As shown in FIG. 4A, a protruding portion 3c of the positioning element 30a is bulging out the trench for contacting and holding the panel on the loader 10. The positioning device 100 further includes a plurality of fixing elements 32 arranged below the positioning element 30a in the trench. Referring to FIG. 5, each of positioning elements 30a includes at least an opening 31 penetrated through the positioning element 30a; and at least a screwing element utilizing the opening to screw and fix the positioning element 30a in the trench. The positioning element 30a and the fixing element 32 utilize the screw or the tenon to lock and fix with each other. As the size of the panel is different, the screw may be loosed and the positioning element 30a may slide to the location of the gap corresponding to the different size of the panel. Once the present positioning device applying to the panel without the PWB, the positioning tool 34 locked beside the loader 10 may be loosen to lock on the fixing element 32 in the trench. The positioning tool 34 is in a rectangular-shape and bar-shape block and may use for increasing the contacting area of the loader 10. In the present invention, depending on the design shape of the trench, the positioning element 30a may also directly utilize the screwing element and the opening therein to lock and fix in the trench.

Referring to FIG. 4B, the positioning element 30b is in a L-shape profile and bulging out the trench, and wherein the protruding portion of the positioning element 30b is extended to the direction of the loader 10 and contacting and holding a side edge of the panel. Each of positioning elements 30b includes at least a opening penetrated through the positioning element 30b; and at least a screwing element utilizing the opening to screw and fix the positioning element 30b in the trench. In the polarizer peeling off machine, as peeling off the polarizer, owing to the starting point not in the center portion of the panel, it easily causes the sliding or the movement of the panel in the process so as to scrape the backside or cause the scrap damage. In the present embodiment, the positioning elements 30b may effectively prevent the side sliding of the panel. The positioning element 30b and the fixing element 32 utilize the screw or the tenon to lock and fix with each other. As the size of the panel is different, the screw may be loosed and the positioning element 30b may slide to the location of the edge side of the different size of the panel. Similarly, in the present invention, depending on the design shape of the trench, the positioning element 30b may also directly utilize the screwing element and the opening therein to lock and fix in the trench.

Referring to FIG. 4C, owing to an upward force generated as peeling off the polarizer will cause the warped panel, in the present embodiment, there are a plurality of vacuum suction pipelines 40a, 40b, 40c, 40d, 40e, 40e arranged in the loader 10 to provide those vacuum suction holes on the loader 10 to bear and fix the panel without warping in the vertical direction. Vacuum suction pipelines 40a, 40b, 40c, 40d, 40e, 40e provide the suction force for the vacuum suction holes in different region. In the present invention, the suction force is provided depending on the size of the panel so as to enhance the efficiency of the machine and save the energy. Besides, as the panel is set on the loader 10, there is usually using an anti-static film or an anti-static insulation pad on the loader 10 to prevent the static to damage the panel and the electronics elements thereon.

Accordingly, one of features is to utilize the positioning element and the trench so as the panel positioning device may apply to panels with different size. The positioning element may slide in the trench to move to the appropriate location, which is the gap between the panel and the PWB or the edge side of the panel, and use the screwing element to fix with the fixing element. The arrangement of the trench is depending on the panel shape without the specific limitation. Besides, the shape of the positioning element may be in any shape, such as the cylinder bar, the triangle bar, or others shape, and have a protruding portion bulging out the trench and contacting and holding the panel. Further, the vacuum suction system may be arranged on the loader to increase the stability of the born panel thereon. In accordance with the size of the panel, the vacuum suction system may provide the suction force to the appropriate bearing region of the loader so as to enhance the efficiency of the machine and save the energy.

To sum up the forgoing, the present invention may be applied to fix panels with different size and may effectively overcome the difficulty and increase the stability and the quality of the fixing as the panel arranged a plurality of printed wiring boards thereon so as to prevent the scrap damage of the panel. Besides, the present invention utilizes trenches on the loader and positioning elements in the trench for flexible fixing the panel with different size so as not to increase the size of the machine. Further, the present invention utilizes the combination of a positioning mechanism and a vacuum suction system to effectively increase the stability of the panel and decrease the scrap damage of the panel so as to improve the yield of the panel in the manufacturing process.

While the present invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A panel positioning device comprising:
a loader for loading said panel;
a plurality of trenches arranged on said loader; and
a plurality of positioning elements, wherein at least any one of said positioning elements is arranged in any one of said trenches, and any one of said positioning elements has a protruding portion bulging out said trench and contacting said panel.

2. The panel positioning device according to claim 1, wherein any one of said positioning elements comprises:
an opening penetrated through said positioning element; and
a screwing element utilizing said opening to screw and fix said positioning element in said trench.

3. The panel positioning device according to claim 1, further comprising a plurality of fixing elements, wherein any one of said fixing elements is arranged in any one of said trenches.

4. The panel positioning device according to claim 1, wherein said panel comprises at least one printed wiring board.

5. The panel positioning device according to claim 4, wherein said protruding portion of any one of said positioning elements is extending and penetrated through any one of a plurality of gaps between said panel and said printed wiring board.

6. The panel positioning device according to claim 1, wherein said positioning element is in a L-shape profile and bulging out said trench, and wherein said protruding portion is extending to the direction of said loader and contacting a side edge of said panel.

7. The panel positioning device according to claim 1, wherein said loader further comprises a plurality of vacuum suction holes thereon.

8. A positioning device for a panel with a printed wiring board, said positioning device comprising:
a loader for setting said panel;
a plurality of trenches arranged on said loader; and
a plurality of positioning elements, wherein at least any one of said positioning elements is arranged in any one of said trenches, and any one of said positioning elements has a protruding portion bulging out said trench, penetrated through any one of a plurality of gaps between said panel and said printed wiring board, and contacting said panel.

9. The positioning device for a panel with the printed wiring board according to claim 8, wherein said printed wiring board is stacked with said panel by utilizing the TCP technology.

10. The positioning device for a panel with the printed wiring board according to claim 8, wherein any one of said positioning elements comprises:
an opening penetrated through said positioning element; and
a screwing element utilizing said opening to screw and fix said positioning element in said trench.

11. The positioning device for a panel with the printed wiring board according to claim 10, further comprising a plurality of fixing elements, wherein any one of said fixing elements is arranged in any one of said trenches.

12. The positioning device for a panel with the printed wiring board according to claim 8, wherein said positioning element is in a L-shape profile and bulging out said trench, and wherein said protruding portion is extended to the direction of said loader and contacting a side edge of said panel.

13. The positioning device for a panel with the printed wiring board according to claim 8, wherein said loader further comprises a plurality of vacuum suction holes thereon.

14. A positioning device, applied to a display panel manufacturing equipment for fixing a panel, said positioning device comprising:
a loader arrange on an operation plate of said display panel manufacturing equipment;
a plurality of trenches arranged on said loader; and
a plurality of positioning elements, wherein at least any one of said positioning elements is arranged in any one of said trenches, and any one of said positioning elements has a protruding portion bulging out said trench and contacting said panel.

15. The positioning device according to claim 14, wherein any one of said positioning elements comprises:
a opening penetrated through said positioning element; and
a screwing element utilizing said opening to screw and fix said positioning element in said trench.

16. The positioning device according to claim 15, further comprising a plurality of fixing elements, wherein any one of said fixing elements is arranged in any one of said trenches.

17. The positioning device according to claim 14, wherein said panel comprises at least one printed wiring board.

18. The positioning device according to claim 17, wherein said protruding portion of any one of said positioning elements is extended and penetrated through any one of a plurality of gaps between said panel and said printed wiring board.

19. The positioning device according to claim 14, wherein said protruding portion of any one of said positioning elements is extended and penetrated through any one of a plurality of gaps between said panel and said printed wiring board.

20. The positioning device according to claim 14, wherein said loader further comprises a plurality of vacuum suction holes thereon.
